(19) United States
(12) Patent Application Publication
(10) Pub. No.: US 2008/0077464 A1
(43) Pub. Date: Mar. 27, 2008

(54) Vehicle scheduling and routing with trailers

(75) Inventors: Jens Gottlieb, Schwetzingen (DE); H. Thomas Engelmann, Walldorf (DE); J. Christoph Eckert, Muhlhausen (DE); Carsten G. Schumm, Karlsruhe (DE)

Correspondence Address: SAP/BLAKELY, 1279 OAKMEAD PARKWAY, SUNNYVALE, CA, 94085-4040, US

(73) Assignee: SAP AG

(21) Appl. No.: 11/525,890

(22) Filed: Sep. 22, 2006

(51) Int. Cl. G05B 19/418

(52) U.S. Cl. 705/8

(57) ABSTRACT

Embodiments of the invention include a system for scheduling the shipment of a set of products. The shipment may be loaded into a set of vehicle combinations, which are composed of a combination of vehicles and trailers. The system may include attempts to fill each vehicle and trailer in each vehicle combination. The system may include evaluating a set of constraints on the shipment. The process may include an optimization process to generate the most cost effective use of the available vehicle combinations.

### BACKGROUND

1. Field of the Invention

The invention relates to logistics and supply chain management. Specifically, the invention relates to scheduling loads for vehicles with trailers to fulfill the demand of target locations and optimize the cost effectiveness with which the vehicles and trailers are utilized.

2. Background

Logistics often involves the transportation of goods and services from a source location to a destination location. The transportation services for this movement of goods and services may be provided by transportation services providers (e.g., DHL or UPS), a manufacturer, retailer, distributor or similar entity. The transportation of goods and services is often employed in the process of supply chain management.

A supply chain is a network of retailers, distributors, transportation service providers, warehouses, and suppliers that take part in the production, delivery and sale of a product or service. Supply chain management is the process of coordinating the movement of the product or service, information related to the product or service and money among the constituent parts of a supply chain. Supply chain management also integrates and manages key processes along the supply chain. Supply chain management strategies often involve the use of software to project and fulfill demand and improve production levels.

Logistics is a subset of the activities involved in supply chain management. Logistics includes the planning, implementation and control of the movement and storage of goods, services or related information. Logistics aims to create an effective and efficient flow and storage of goods, services and related information from a source to the target location where the product or source is to be shipped to meet the demands of customers.

The movement of goods and services through a supply chain often involves the shipment of the goods and services between the source location at which the product is produced or stored and the target location where the product is to be shipped such as the wholesaler, vendor or retailer. The shipment of products involves a vehicle such as a truck, ship, train or airplane and involves the planning of the arrangement of the products to be shipped in the vehicle.

The shipment of goods may involve complex constraints. Supply chain management systems are limited in their ability to simulate the loading of a vehicle while ensuring adherence to a complex set of constraints. For example, supply chain management systems are unable to maximize the use of vehicles, especially vehicles with trailers.

### SUMMARY

Embodiments of the invention include a system for scheduling goods for a set of vehicle combinations for shipment. The scheduling system may include a transportation scheduling module. The transportation scheduling module may be used to determine a vehicle combination or set of vehicle combinations by which a product may be scheduled to be transported. The vehicle combination may include a vehicle or set of vehicles and a trailer or set of trailers in which the product may be placed. This scheduling may include evaluating a set of constraints on the shipment, vehicle and trailer, as well as on the vehicle combination. The constraints may include a complex logical statment and may be based on the requirements of the scheduling, location, routing, products, compartment, vehicle, trailer, and vehicle combination.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1A is a diagram of a set of vehicles and trailers that may be combined into vehicle combinations.

FIG. 1B is a diagram of one embodiment of a-vehicle combination graph.

FIG. 2A is a diagram of one embodiment of an order replenishment management system.

FIG. 2B is a diagram of one embodiment of a vehicle scheduling system for vehicles with trailers.

FIG. 3 is diagram of one embodiment of a transportation determination module.

FIGS. 4(A)-4(D) are flowcharts of example move operations.

FIG. 5 is a flowchart of one embodiment of a process for assigning transportation orders to vehicle combinations.

FIG. 6 is a diagram of one embodiment of a user interface for the scheduling system.

### DETAILED DESCRIPTION

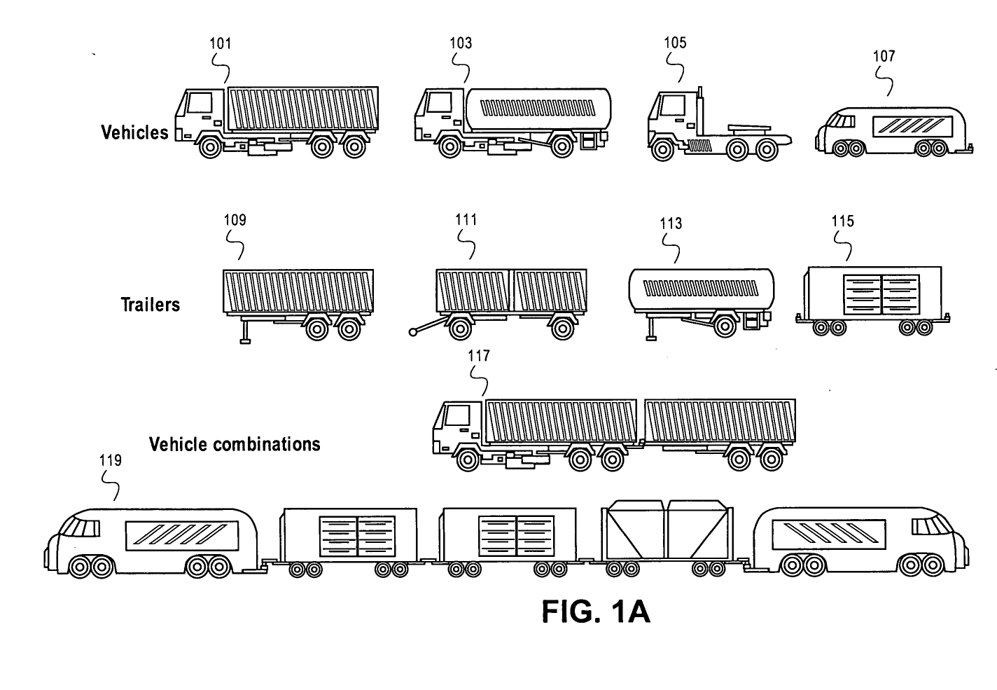

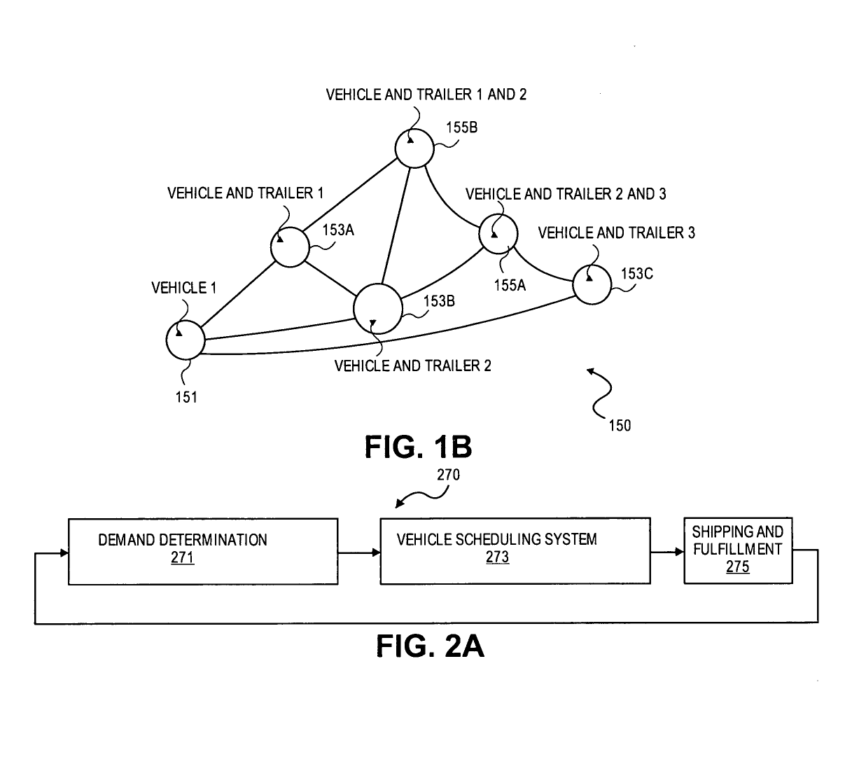

FIG. 1A is a diagram of one embodiment of a set of vehicles and trailers that may be combined as vehicle combinations. Vehicles may refer to any type of object that is capable of self propulsion such as a truck, train engine, plane, ship or similar type of vehicle. A vehicle may have a standard storage compartment 101. A vehicle may have any type of specialized storage or space that is fixed to the vehicle. For example, a vehicle 103 may have an airtight tank or set of airtight tanks to carry liquids or gases. In a further embodiment, a vehicle 105, 107 may not have any significant storage capacity. For example, a truck 105 without a trailer or a train engine 107 is a vehicle without any significant storage capacity.

A trailer may refer to any type of object that is capable of movement when externally propelled by a vehicle and capable of holding items for transport. For example, tractor trailers 109, 111, 113, box cars 115, barges and similar conveyances may be trailers. The trailers may have any number or type of compartments. For example, a trailer 109 may have a single standard full length compartment. Another example trailer 111 may have two separate compartments. A trailer 113 may have special properties, restrictions or characteristics or include a set of compartments with such characteristics. As used herein a set may refer to any number (i.e., positive integer) of items including one. For example, the compartment may be airtight and hold liquids or gases, such as a tanker trailer 113.

The trailers may have any type of attachment or movement mechanism. The trailers may be designed to couple to specific types or models of vehicles or other trailers. For example, a trailer 109 may be designed to couple directly to a vehicle 105. A trailer 111 may be designed to couple to other trailers 109 having the same movement mechanism. For example, trailers with tires 109, 111 may be used together, but not with a trailer 115 that is designed for rails. Trailers and vehicles may have numerous characteristics that restrict their ability to be combined with one another. Restrictions may be related to the size, mode of transportation, coupling mechanism, range, capacity and similar characteristics. In some cases, restrictions may be greater on a vehicle combination than on the constituent parts of the vehicle combination. For example, a vehicle from a vehicle combination may be able to reach a specific location and a trailer may also be able to reach the same location. However, the trailer and vehicle combined for a vehicle combination may be restricted from a specific location, because combined they are too large for the roadways leading to the location or for similar reasons. In another example, a vehicle may have a capacity of 40 tons and a trailer may have a capacity of 40 tons, but the two in combination may only have a capacity of 60 tons, because the connection of the trailer to the vehicle may restrict the storage space of the vehicle.

As used herein, a vehicle combination may refer to any feasible combination of vehicles and trailers. There may be a one to many relationship between vehicles and trailers such as a truck with a set of trailers 117 or a many to many relationship between the vehicles and trailers such as a train with multiple engines and box cars 119. Vehicle combinations may have various relationships with the different types of vehicles and trailers. A specific type of trailer may be used in different vehicle combinations. Alternatively, a vehicle combination may not include any trailers. Similarly, a type of vehicle may be used in different vehicle combinations. A vehicle or trailer may be exclusively used in a particular vehicle combination or may be used exclusively in vehicle combinations with other trailers or vehicles. Determination of the types of vehicles and trailers and the numbers of each in a vehicle combination may be a separate consideration from determining whether any of the type of vehicle or trailer is available to form a vehicle combination.

FIG. 1B is a diagram of one example vehicle combination graph. A vehicle combination graph may be constructed to represent a set of related vehicle combinations. Multiple vehicle combination graphs may be constructed to model possible transitions between feasible vehicle combinations for a fleet of vehicles and trailers. Separate graphs may be constructed for vehicle combinations that do not intersect, that is, where it is not possible to transition from one set of vehicle combinations to another.

The example vehicle combination graph 150 depicts the feasible combinations of a single vehicle (vehicle 1) with three different types of trailers (trailers 1, 2 and 3). The vehicle without any attached trailers is represented by a node 151. From this state it is possible to transition to three different vehicle combinations where the vehicle is attached to any one of the three trailers represented by nodes 153A-C. The edges between the nodes may be bidirectional, such that it is possible to return to the state of a lone vehicle from any of these vehicle combinations. The edges may represent a single change in the vehicle combination or a set of changes. For example, an edge may indicate the addition or subtraction of a trailer from a vehicle combination or it may indicate the addition or subtraction of any number of vehicles or trailers from the vehicle combination.

The graph further depicts that it is possible to combine the vehicle with trailers 1 and 2 (node 155B) or with trailers 2 and 3 (node 155A). These nodes may be reached along the edges connecting them to the single trailer nodes 153A-C. The graph implicitly indicates that it is not possible to combine the vehicle with trailers 1 and 3 or with more than two trailers at a time, because nodes representing such vehicle combinations are absent from the graph. Graph edges between node 155B and 155A and between node 153A and 153B are examples where multiple changes are represented by a single edge. Graphs may also be constructed to represent vehicle combinations that include multiple vehicles, larger numbers of trailers and similar scenarios. These graphs are utilized, as discussed further herein below, to determine feasible transitions from current vehicle combination configurations to optimize the use of available resources. Restrictions on the combinations of trailers and vehicles that render them infeasible may include industry regulations, traffic ordinances, technical restrictions (e.g., vehicle incapable of pulling particular size of trailer) or other legal or rules based restrictions.

In one embodiment, the nodes of a graph may be used to represent types of vehicle combinations that are feasible. Further checks would then be necessary to determine the availability of the constituent parts of each type of vehicle combination. In another embodiment, vehicle combination graphs may be used to represent actual vehicles and trailers that are available.

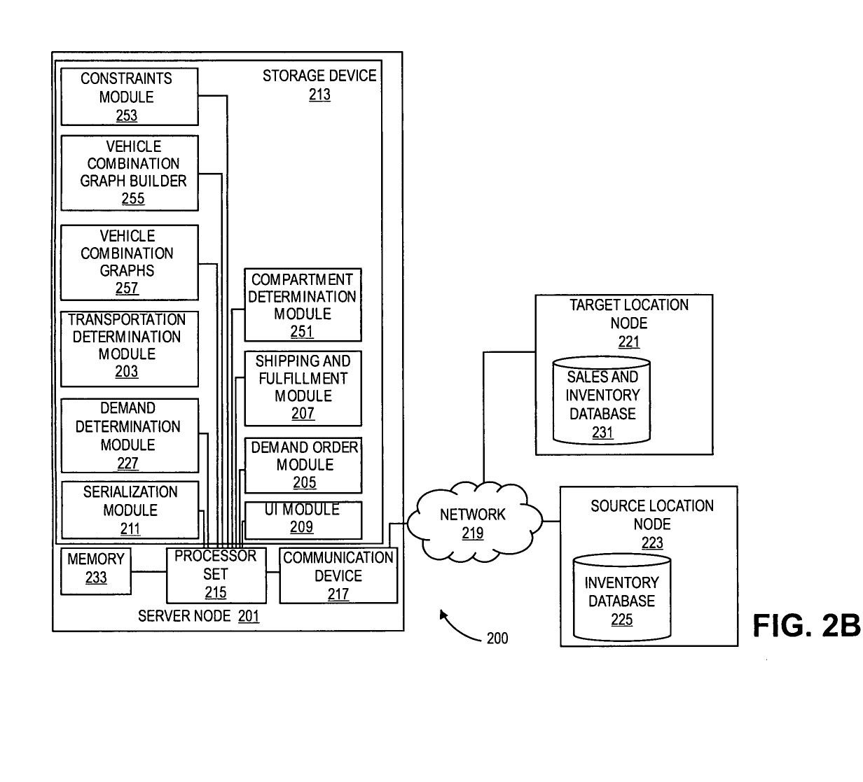

FIG. 2A is a diagram of an order replenishment management system. The order replenishment system 270 may be utilized in a supply chain or similar context to manage the movement of goods between source locations and target locations. A source location may be any location in a supply chain that may provide a product or similar items. A target location may be any location in a supply chain that may receive a product or similar items. A single location may be both a source and target location dependent upon the context. For example, a factory may be a source location that ships products to a warehouse or similar location. The same factory may be a target location for receiving component parts for a product assembled at the factory. Similarly, other locations including warehouses, distribution centers, retailers and similar locations may be either a source or target location dependent on the shipping context. The embodiments discussed herein primarily use an example where a factory or warehouse is the source location and the end user or retailer is the target location for sake of clarity. One skilled in the art would understand these are examples of target and source locations and other target and source locations may be used.

In one embodiment, an order replenishment management system 270 may receive sales data, inventory data from retailers, inventory data from warehouses or similar demand data. Order replenishment management system 270 may then generate orders for shipments of products from source locations like factories and distribution centers to meet the demand generated by customers or end users. In one embodiment, order replenishment management system 100 receives sales, inventory or similar demand data from a set of retailers, warehouses and similar sources (block 271). The demand data may be received at regular intervals (e.g., days, months and similar time intervals).

The demand data that is received from the retailers, warehouses and similar sources is processed to predict the future or current demand for a set of products. The projected demand for a set of products may be for any time period (e.g., a month, week, day, hour or similar measurement of time). The projected demand may also include a prediction of demand for subdivisions of the time period of the projection. For example, a projection of demand for a month may have a breakdown of that demand on a day by day or week by week basis.

The projected demand data may be used by a vehicle scheduling system to determine the best manner of transporting a set of products to a target location (block 273). The determination of a route for sending products to the target location may involve the analysis of the availability of demanded products at various source locations, the cost of shipping the products from the source locations to the target locations, the utilization of the capacity of a vehicle combination for shipping the products from the source location to the target location and the types and capacity of the compartments and trailers used in the vehicle combination.

The determination of the vehicle schedule may include a simulation of building a load (e.g., a shipment of products) in a vehicle combination. The building of a load may involve consideration of the size, weight, product types and similar characteristics of a shipment. The loading of the shipment into a vehicle combination may be required to meet a set of constraints. For example, the vehicle combination may have a weight limit and a volume limit, certain products may not be properly shipped in the same vehicle, trailer or vehicle combination as other products and similar shipping constraints may be a part of the loading simulation. This simulated load may also be applied to trailers within a vehicle combination. Each trailer may have weight, volume, pallet limits or similar capacity limits. Some trailers, vehicles and vehicle combinations may have restrictions on the type of products that can be shipped within them (e.g., an open trailer may not store items that cannot withstand exposure to weather or changes in temperature). Further restrictions may include the incompatibility of certain products with one another such that they cannot be shipped in the same trailer, vehicle or vehicle combination. Any combination of constraints may be considered in determining a load for a vehicle, trailer or vehicle combination. For example, constraints may make it possible to place a first product in a first trailer and a second product in a second trailer of the same vehicle combination. However, another constraint may prohibit a third product and fourth product from being placed in the same vehicle combination, because they are hazardous if combined, which could occur in accident.

The vehicle scheduling generates a set of transportation orders. Each transportation order indicates a set of products to be transported from a source location to a target location. Each transportation order may be assigned to a vehicle combination by a transportation determination module. The transportation order may be further assigned to a vehicle or trailer of a vehicle combination or across multiple vehicles or trailers of a vehicle combination. The assignment of products to vehicles, trailers and vehicle combinations may be represented as a transportation plan. A transportation plan may include a set of transportation orders assigned to vehicles, trailers, vehicle combinations routing stops for a vehicle, a route schedule with start and end times for activities (e.g., deliver, rest or similar activities) and similar information.

After the transportation orders for shipping the products are determined, fulfillment instructions may be sent out to the origination site (block 275). The shipping and fulfillment instructions may be sent electronically to the source location. In one embodiment, the loading simulation and transportation orders are determined at a central server node. The shipping and fulfillment instructions or the vehicle schedules, transportation plan or similar data may be sent to a remote node at the source location through a network or similar communication system.

FIG. 2B is a diagram of one embodiment of a vehicle scheduling system for vehicle combinations. In one embodiment, the scheduling system 200 may include a server node 201, target location node 221 and source location node 223. Server node 201 may be a single central server, a set of servers sharing the scheduling tasks or similar system. The scheduling system 200 may include multiple target location nodes 221 or multiple source location nodes 223.

In one embodiment, target location node 221 may include a sales or inventory database 231. The sales database 231 tracks the sales of a retailer, vendor, warehouse or similar source of demand. The inventory database 231 tracks the inventory levels of the products supplied by the scheduling system 200. Target location node 221 may be in communication with server node 201 through a network 219, point to point link or similar communication systems.

In one embodiment, source location node 223 may include an inventory database 225. The inventory database 225 tracks the inventory levels of the products to be supplied by the scheduling system 200. Source location node 223 may be in communication with server node 201 through a network 219, point to point link or similar communication systems.

In one embodiment, server node 201 may include a communication device 217 to receive demand data including sales data or inventory data from the target location node 221 through network 219 or similar communications system. Communication device 217 may be a modem, network card or similar communications device.

In one embodiment, the incoming sales and inventory data may be processed by a demand determination module 227. Demand determination module 227 may utilize the data supplied by target location node 221 to generate a set of demand orders that may be stored in a demand order module 205. In one embodiment, incoming demand data may include various types of data, such as demand related to special promotions, demand for common product restocking or similar data. Demand determination module 227 or similar module may adjust, filter or sort data according to type to prevent skewed demand orders or generate demand orders for a specific type of product demand. The demand determination module 227 may be a component of a demand determination system that includes demand projection and similar functionality. In another embodiment, demand determination is a separate system from the vehicle scheduling system.

In one embodiment, demand order module 205 may be a data structure that stores and tracks a set of products for which demand has been predicted by demand determination module 227. For example, demand determination module 227 may determine that one hundred units of a product should be shipped to a destination (e.g., a retailer, warehouse or similar destination) each week and that fifty of the product units should be shipped on a Monday and ten units should be shipped Tuesday through Saturday to meet the projected demand.

In one embodiment, transportation determination module 203 may be an application that schedules the loading of a set of vehicle combinations with a shipment of products (e.g., generates transportation orders) based on demand data from a demand order module. For example, a transportation determination module 203 may be used to determine how the fifty units of the Monday shipment will be scheduled onto a set of vehicle combinations.

The transportation module 203 may work on any type of vehicle combination, including vehicle combinations including trucks, trains, ships, airplanes and similar vehicles. Similarly, the transportation determination module 203 may determine routing, activities, scheduling and similar information for each vehicle combination. In one embodiment, the transportation determination may call on or utilize a vehicle combination graph 257 generated by a vehicle combination graph builder 255. The vehicle combination graph 257 models sets of possible vehicle combinations and the possible transitions between these combinations. The graph builder 255 analyzes available trailer and vehicle data to determine possible vehicle combinations and the interrelationships between them to generate a graph that can be utilized by the transportation determination module 203.

In one embodiment, the transportation determination module 203 may work in conjunction with or call on the services of a compartment determination module 251. Compartment determination module 251 may determine whether a set of products of a transportation order tentatively assigned to a vehicle or a trailer can be loaded into the compartments of the respective vehicle or trailer while meeting the constraints of these compartments and the products in the transportation order. The transportation determination module 203 and compartment determination module 251 may be utilized in conjunction with any type of vehicle combination. The compartment determination module 251 may generate a configuration data structure that stores the allotment of transportation orders to compartments for each trailer and vehicle in a vehicle combination.

In one embodiment, transportation determination module 203 may work in connection with a constraints module 253 when determining the loading of the set of vehicle combinations. Constraints module 253 may be a data structure that includes a set of shipping rules or other constraints on the shipping of products using a set of vehicles, trailers and vehicle combinations. Shipping rules and constraints may include limitations on the combinations of certain products in a single transport, weight limitations of a transport, size of a transport, default shipment configurations, number of transportation orders per transport, combination of demand orders or products from different sources and similar data. Similarly, transportation determination module 203 may utilize the constraints module 253 to determine constraints applicable to trailers and apply these constraints to product configurations for the trailers. In addition, some constraints may be specific to trailers, such as trailer type, number of transportation orders per trailer, combination of products, demand orders or products from a particular source in a trailer and similar constraints. Similarly, some constraints may be specific to a vehicle or vehicle combination.

In one embodiment, the transportation determination module 203 may attempt to create “full” loads by maximizing the utilization of the capacity of a set of vehicle combinations and each vehicle and trailer in each vehicle combination used for shipping. Maximizing the utilization of a set of vehicle combinations and their vehicles and trailers can reduce the per item or unit shipping costs. Maximum utilization may be measured in any appropriate manner such as the number of shipping units or pallets that a vehicle, trailer or vehicle combination may carry, the weight limit a vehicle, trailer or vehicle combination may carry, the volume of goods that a vehicle, trailer or vehicle combination may carry or by use of similar criteria. Maximum utilization may mean that the carrying capacity is used to its fullest extent (e.g., it has met its weight limit or its volume limit or shipping limit) or falls within an acceptable range (e.g., ±1000 pounds of the vehicle or trailer weight limit). This range may be defined to suit the needs of the order replenishment system or user.

In one embodiment, the transportation determination module 203 may not fill all of the vehicle combinations, trailers or vehicles to a maximum capacity for technical, business, logistical or similar reasons. A false or temporary maximum capacity may be used in place of an actual maximum capacity. In one embodiment, the false maximum capacity may be used as a default loading goal. Transportation determination module 203 may load some of the vehicles, trailers and vehicle combinations only up to the false maximum capacity to leave room on a transport to accommodate a product that may be added at a later date or stop, leave room to maneuver products during unloading or for similar reasons. The number of vehicle combinations which are filled up to the false maximum capacity may be kept at a minimum. Similar alterations and accommodations may also be implemented to the capacity characteristics of vehicles and trailers.

When the desired load configuration has been determined by the transportation determination module 203 the results may be sent to a shipping and fulfillment module 207. Shipping and fulfillment module 207 may generate a formatted set of loading configurations or instructions. Shipment and fulfillment module 207 may then output the loading configurations and instructions in the form of a load order or similarly formatted data or modules to source location node 223. In one embodiment, the load configuration instructions may be saved in the form of a transportation plan. This plan may be a formatted file or data structure indicating the organization of transportation orders and products amongst a set of vehicles and trailers. The shipment instructions may be sent through a communication device 217 over a network 219 or similar communications system. Source location node 223 may be located at a source location such as a factory, warehouse or similar product source location.

In one embodiment, the vehicle scheduling system 200 may include a user interface module 209. The user interface module 209 may provide an interface for a user such as an administrator or other user (e.g., a transportation planner or similar user) to view transportation orders, transportations plans and similar data. The user interface may also allow editing of these data structures and the setting of related characteristics, constraints and similar data.

In one embodiment, the vehicle scheduling system 200 may include a serialization module 211. The serialization module 211 may transform a transportation plan or set of transportation orders into a format where they can be analyzed by the compartment determination module 251. The compartment determination module 251 may process transportation orders one at a time as it determines the assignment of transportation orders to compartments using a compartment configuration data structure. The serialization module 211 may be used to provide transportation orders to the compartment determination module 251 one at a time from an already created transportation plan or a set of transportation orders.

In one embodiment, the modules of vehicle scheduling system 200 are a set of software instructions, data structures, electronic devices or similar implementations. In one embodiment, the data structures and instructions may be constructed using an object oriented paradigm or similar implementation. In one embodiment, the instructions and data structures are stored on a storage device 213. The instructions may be executed or the data structures loaded by a set of processors 215. The set of processors may utilize a system memory 233.

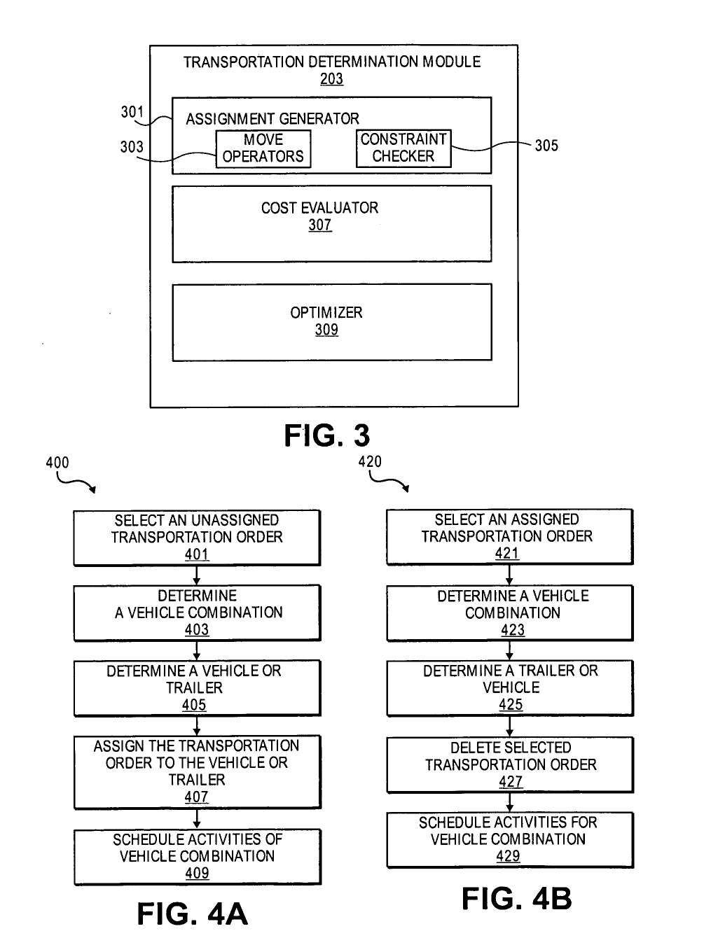

FIG. 3 is a diagram of one embodiment of a transportation determination module. In one embodiment, the transportation determination module 203 may include an assignment generation component 301, a cost emulator 307 and an optimizer 309. The transportation determination module may generate an optimal transportation plan for a set of vehicles and trailers based on an input set of transportation orders; this may include the determination of an optimal set of vehicle combinations based on the available vehicles and trailers.

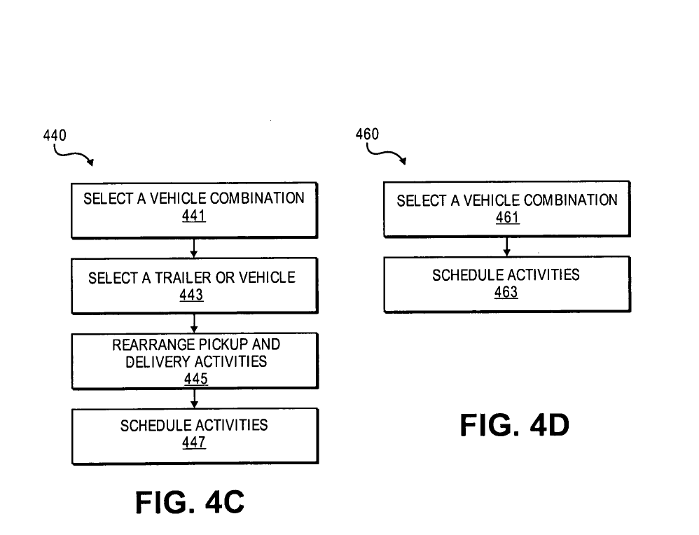

In one embodiment, the assignment generator may include a set of move operators 303 for altering the transportation plan. Example move operators are discussed in further detail in relation to FIGS. 4A-4D. The move operators 303 may insert or delete transportation orders from the transportation plan, change a sequence or schedule of activities within a transportation plan or perform similar operations. The assignment generator 301 may also enforce constraints through a constraints checker 305 to determine an optimal solution.

In one embodiment, the assignment generator 301 assigns transportation orders to a set of vehicle combinations such that all constraints are met. The constraints may be related to vehicle restrictions or limitations, route limitations, trailer restrictions or limitations or similar types of constraints. Constraints may also be formulated independent of the restrictions and limitations of the input data set. For example, a constraint may be applied that requires each of the transportation orders to be assigned to a specific vehicle, trailer or vehicle combination. A constraint may also implement a user's preferences during optimization. For example, a user may have a preference that a particular transportation order be assigned to a particular vehicle combination or that selected pickup or delivery activities have predefined starting times.

In another embodiment, some constraints may be violated during optimization. As a result a transportation plan may not meet all applicable constraints. In a further embodiment, the optimization process may attempt to satisfy all constraints, but violations may be permitted during the optimization process. Constraints may be divided into soft constraints and hard constraints. A soft constraint may be violated. These violations of the soft constraints may be weighted or penalized to minimize the number and degree of the violations. Hard constraints may be constraints that must not be violated. An optimization process may have a threshold for constraint compliance. For example, an optimization process may accept a transportation plan that has constraint penalties below a designated value. An optimization process may also check through a constraint checker 305 or similar operator to determine if any constraints are mutually exclusive, that is they cannot both be satisfied at the same time. The optimization process may prefer one conflicting constraint over another, may apply a penalty system or similarly resolve conflicts

Any of the following constraints may be enforced during the optimization process for vehicles, trailers or vehicle combinations: incompatibilities between vehicle combinations and transportation order, that is, certain products must not be transported on certain vehicle combinations; incompatibilities between vehicle combinations and locations or routes, that is, certain vehicle combinations are not allowed to travel to particular locations or along certain routes; limits on driving capabilities, that is, certain vehicle combinations cannot travel more than a predetermined distance or duration limit, or can have a maximum number of stops; start or end locations for a vehicle combination, vehicle or trailer; limits on loading capacities of vehicles, trailers and vehicle combinations; incompatibilities between a transportation order and a vehicle, trailer or vehicle combination; incompatibilities between two transportation orders in the same trailer, vehicle or vehicle combination; incompatibilities between types of vehicles and trailers that aren't represented in vehicle combination graph or similar constraints. These constraints may be categorized as hard constraints. Soft constraints may include distance preferences for trips, preferred delivery times, number of stops or transfers between vehicles, trailers or vehicle combinations or similar constraints. In one example, a vehicle combination may have a hard constraint of 1000 km for a maximum distance for a trip, but 500 km for soft constraint indicating a preference that wear and tear should be limited.

In one embodiment, generated transportation plans may be evaluated by the cost evaluator 307. In one embodiment, the cost evaluator 307 may employ a total cost function to characterize a transportation plan. The total cost function associates a total cost value with the evaluated transportation plan. The total cost value can include actual costs representing the transportation activities of vehicles, trailers or vehicle combinations, but also penalty cost contributions from constraints; that is, constraints that are not strictly enforced may be evaluated as penalties against the transportation plan. These penalties may represent an actual cost incurred by the violation or abstract penalties to implement user preferences.

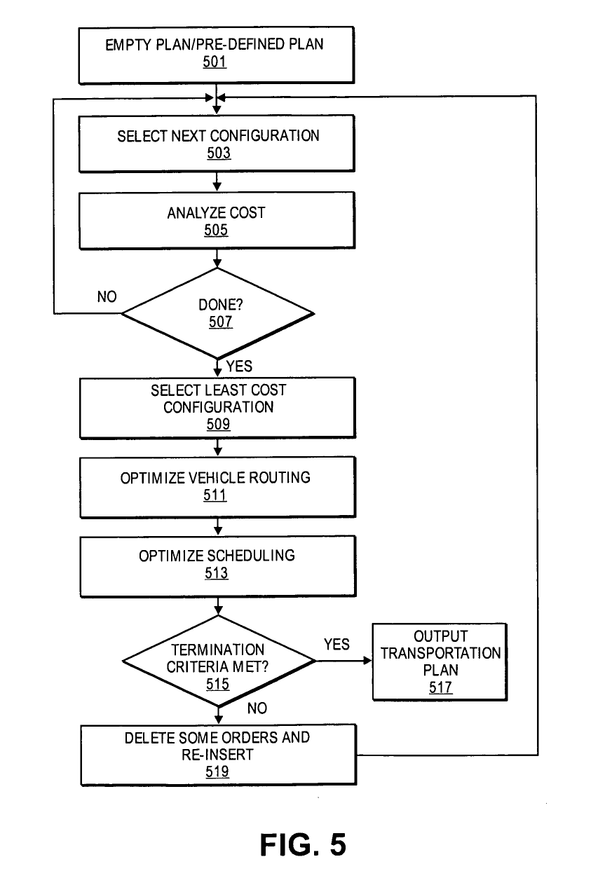

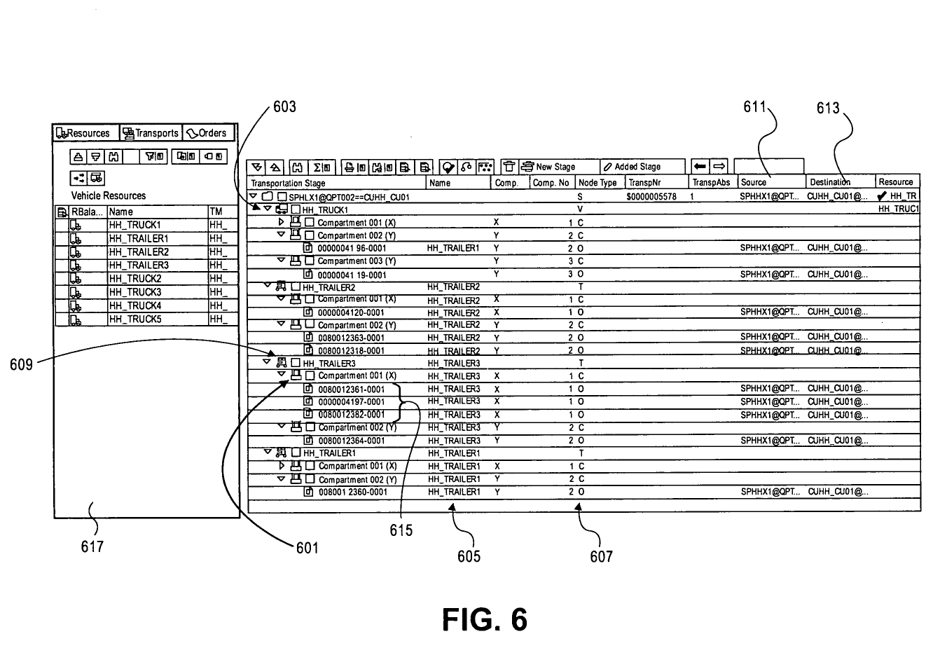

In one embodiment, an optimizer 309 may utilize the assignment generator 303 to obtain assignments from the assignment generator 301 analyze them using the cost evaluator 307 to generate an optimal solution. In another embodiment, the optimizer 309 may generate a transportation plan starting with an empty plan. The assignment of transportation orders to trailers, vehicles and vehicle combinations involves an optimization problem. Any type of optimization algorithm may be utilized in solving this optimization problem. For example, a local search, a tabu search, simulated annealing, evolutionary algorithms or other metaheuristics may be used. Also, mixed integer linear programming, constraint programming and other exact techniques or derived methods that may involve backtracking may be employed. One example embodiment of an optimization process involving a local search is discussed below in regard to FIG. 5.

FIGS. 4(A)-4(D) are flowcharts of example move operations. Move operations may be used by the optimization process to generate or alter transportation plans. These move operators can be applied to generate an optimal solution. The move operators can be applied in any order or combination. The move operators may be used to satisfy constraints. A transportation plan that does not meet constraints may have each move operator iteratively applied until the constraints are met. However, if the constraints are not met by a move operator then the changes effected by the move operator are not stored and the transportation plan is not changed. Move operators may operate on a single transportation order or on a set of transportation orders. For sake of clarity the operators are discussed as example embodiments operating on a single transportation order.

Generally, the optimization process (an example of which is discussed in greater detail in regard to FIG. 5 below) is an iterative process with insertion and deletion phases, during which orders are assigned to vehicle combinations including the vehicles and trailers of those combinations. The assignments are changed continuously and the best transportation plan is tracked. Each iteration may involve the evaluation of a transportation plan that includes a change in the usage of trailers or vehicles in vehicle combinations or a change in the assignment of transportation orders. The optimization process also has special phases where routing and scheduling for each vehicle combination is optimized. The changes to the transportation plan that the optimization process iterates through are generated by the application of move operators that add vehicles and trailers to vehicle combinations, change vehicle combinations, drop trailers and vehicles and perform similar operations. The selection of move operators to be applied to a transportation plan may be based on probabilities specified by a user, default probabilities or similar factors.

FIG. 4A and FIG. 4B depict two basic move operators, an insertion method 400 and deletion method 420, respectively. The insertion method 400 inserts an unassigned transportation order or set of transportation orders into a transportation plan and the deletion method 420 deletes a transportation order or set of transportation orders from a transportation plan. Using combinations of these move operations a transportation order may be moved from a first vehicle combination to a second vehicle combination by inserting the transportation order into the second vehicle combination and deleting it from the first.

In one embodiment, the insertion operation receives or selects a transportation order or set of transportation orders to be inserted (block 401). In one embodiment, the selection of the transportation order or set of transportation orders may be random, based on defined criteria (e.g., largest transportation order first or similar criteria), pre-ordered for processing or similarly selected.

The process may then determine a vehicle combination to place the transportation order within (block 403). The determination process may iterate through available vehicles, trailers or vehicle combinations and evaluate multiple scenarios for inserting the transportation orders or set of transportation orders. The following scenarios may be evaluated to determine the best method for inserting the transportation orders or set of transportation orders: insertion into an already used vehicle; insertion into a used vehicle combination; insertion into an unused vehicle with capacity; insertion into a vehicle combination by adding a vehicle or trailer, where the vehicle or trailer added may have been previously used or unused. Each scenario may be evaluated and the scenario with the best cost may be selected.

In one embodiment, for unused vehicles and trailers only one vehicle or trailer per class may be evaluated, because each other member of the class would have similar utility and constraints. If an insertion order for multiple transportation orders is to be processed together then some special characteristics may be used to select the group that can be placed on a vehicle combination

In one embodiment, the transportation order or set of transportation orders is assigned to a particular vehicle or trailer of a vehicle combination during the preceding process. In another embodiment, after the vehicle combination is selected a trailer or vehicle (if the vehicle has storage capacity) is selected from the vehicle combination to place the transportation order that meets the relevant constraints (block 405). The transportation order may then be stored in the transportation plan as associated with the selected trailer and vehicle combination (block 407).

In one embodiment, the activities for the transportation order are then scheduled and added to the transportation plan (block 409). The activities may include delivery activities, pickup activities and similar activities. The scheduling of activities may be restricted by applicable constraints and other scheduled activities in the transportation plan.

FIG. 4B is a diagram of one embodiment of a deletion method 420. In one embodiment, the deletion operation receives or selects a transportation order or set of transportation orders to be deleted (block 421). In one embodiment, the selection of the transportation order or set may be random, based on defined criteria (e.g., largest transportation order first or similar criteria) or similarly selected. In another embodiment, the transportation order to be deleted may be designated by a user or another component or program.

The process may then identify a vehicle combination for the transportation order (block 423). In addition, for multiple transportation order deletions, several deletion criteria may be set to remove all orders for a specific trailer, vehicle, vehicle combination or specific compartments, to remove all transportation orders with specific identification or combinations thereof. A vehicle or trailer from the vehicle combination may then be determined that is associated with the transportation order to be deleted (block 425). The transportation order or set of transportation orders may then be deleted (block 427) The selection process may iterate through available vehicle combinations and select the first vehicle combination that meets the relevant constraints or may iterate through all of the vehicle combinations to find the optimal vehicle combination if the deletion removes the last transportation order for a trailer.

In one embodiment, the activities for the transportation order are then rescheduled and updated for the transportation plan to take into account the deletion of the transportation order (block 429). The activities may include delivery activities, pickup activities and similar activities. The scheduling of activities may be restricted by applicable constraints and other scheduled activities in the transportation plan.

FIG. 4C is a flowchart of a move operation that performs a routing method 440. The routing method 440 does not remove transportation orders or add transportation orders. The routing method 440 alters the sequence of the activities of a route for a vehicle combination in a transportation plan. The routing method 440 selects a vehicle combination or identifies a vehicle combination to process (block 441). In one embodiment, a transportation order that has recently been reassigned within a transportation plan may trigger a routing method call to optimize the transportation plan for the new assignment. In other embodiments, transportation orders may be selected randomly, designated by a user or similarly selected for application of the routing method. After a vehicle combination has been determined that is associated with a transportation order the relevant trailer may be determined (block 443).

In one embodiment, routing method 440 rearranges the pickup and delivery activities for the transportation order in accordance with its new assignment (block 445). As a result of the change in the sequence of activities the vehicle combination will travel on a different route according to the activities. Activities may be rearranged by standard methods used for the traveling salesman problem. Standard methods include inverting an activity sequence, moving an activity to a different spot in the activity sequence, swapping the position of two activities in the sequence or similar movement of activities. Activities may also be reordered in groups or subsets of the activities. After an activity sequence is determined the activities may be scheduled (block 447).

FIG. 4D is a flowchart of one embodiment of a move operation for scheduling 460. In one embodiment, the scheduling method 460 selects or is provided a vehicle combination as an input (block 461). The scheduling method applies constraints of the vehicle combination, the transportation orders, travel space constraints (e.g., road limitations between stops) and similar constraints (block 463). The scheduling operation may not change the order of activities. Rather, the scheduling operation determines start times or end times for activities. The activities may be scheduled to minimize waiting times for a vehicle combination. For example, a starting time may be designated for an early or late activity and the remaining activities may be scheduled forward or backward from these activities to accommodate them.

In one embodiment, more complex move operators may be provided. These complex move operators may be enhancements of the basic move operators or utilize the basic move operators. The complex move operators may be used to exchange orders, exchange trailers or optimize trailers.

In one embodiment, a complex move operator may be provided to allow the exchange of orders between vehicle combinations or between vehicle or trailers in a vehicle combination. This move operator may evaluate scenarios that include removing a trailer with its transportation orders from a vehicle combination and adding the transportation orders to another vehicle combination. Another similar move operator may evaluate scenarios that include removing a vehicle with its transportation orders from a vehicle combination and adding the transportation orders to another vehicle combination. This scenario may be restricted to vehicle combinations with multiple vehicles.

In one embodiment, a complex move operator may be provided to exchange trailers. Scenarios that may be evaluated for implementation include: uncoupling a trailer from a vehicle combination so that the remainder of the vehicle combination can continue on route and return later for the trailer; and a vehicle picks up a trailer at a location, runs a route and returns the trailer or leaves it at another location. This move operator can be used to generate even more complex scenarios to be considered where multiple exchange operations are undertaken.

In one embodiment, a move operator may optimize the use or efficiency of trailers. This operator may involve the checking of assignments of transportation orders to a vehicle combination or a specific trailer. The optimization may allow for unneeded trailers or vehicles to be identified by more efficiently using the capacity of other trailers or vehicles in the vehicle combination. This move operator may be implemented by building a local optimization process that combines the other operators for use on a single trailer. The optimization of each trailer may include more efficient placement of orders, dropping trailers to minimize mileage on the trailers, transfer of transportation orders to other vehicle combinations, vehicles or similar optimizations. For example, a trailer may be identified that can be dropped anywhere and the move operator may analyze if it is beneficial to drop the trailer from a vehicle combination to reduce mileage or gas or for similar reasons. A similar operation may be performed on vehicles as well.

In one embodiment, the complexity of analyzing some of the scenarios of the complex move operators or the use of multiple move operators may be computationally intensive. The analysis may be simplified by fixing components of the analysis. For example, the relative ordering of activities of a vehicle or trailer may be fixed, then the trailer exchange operation is done and afterwards the relative ordering is optimized per vehicle combination separately.

FIGS. 5 is a flowchart of one example embodiment of an optimization process. In one embodiment, the process may start with an empty transportation plan (block 501). In another embodiment, the process may start with a pre-defined transportation plan generated by an assignment generator, by manual input, from a previous optimization run or similarly generated plan. The pre-generated transportation plan may be processed on a transportation order by transportation order basis, by vehicle combination, trailer or similarly processed.

The process may iterate through the transportation orders input or in the pre-generated transportation plan to generate a new transportation plan (block 503). This process may determine configurations or permutations of the possible transportation plans and may track previously generated plans to prevent the same plan from being generated. In one embodiment, the optimizer of a transportation determination module may utilize an assignment generator including a set of move operators and a constraint checker to generate the transportation plans to be evaluated.

The transportation plan may then be analyzed for cost (block 505). In one embodiment, the cost estimates for a transportation plan may encompass: transportation costs including fuel, driver wages and similar transportation costs; resource utilization; late or early penalties; lost opportunity costs; fixed costs and similar measurements of transportation plan costs. Any combination of factors or data may be used to generate the cost estimate. A user may specify the cost estimate criteria or algorithms for determining the cost estimate. In one embodiment, each transportation plan may be evaluated using the same cost estimation calculation. In another embodiment, different criteria may be applied to different plans per user direction or to reflect changes in plan generation criteria or for similar reasons. In one embodiment, an optimizer of a transportation determination module may utilize a cost evaluator to determine the cost estimates for each transportation plan.

In one embodiment, each change in a plan may be generated using move operators of the assignment generator discussed above. In addition, the process may rely on a vehicle combination graph such as the example vehicle combination depicted in FIG. 1B discussed above. Each transportation order that may be added or removed from a transportation plan may be processed by the move operations of the transportation determination module. Specifically, the move operations may use the vehicle combination graph to determine how to modify a vehicle combination in response to adding a transportation order that exceeds a vehicle, trailer or compartment capacity or fails to meet the vehicle combination constrains or deleting transportation orders that allow a trailer or compartment to be removed from the transportation plan

In one embodiment, these operations determine a current location in the graph for an associated vehicle combination. The edges leaving the node of the associated vehicle combination indicate possible changes to the current vehicle combination leading to a different vehicle combination. For example, adding a first transportation order to a vehicle with no storage capacity 151 may provide three edges from the associated node allowing the vehicle combination to be changed to a vehicle with one of 3 different trailers 153A-C attached to it. A subsequent addition of a transportation order that requires space not present in vehicle combination may be added by further altering the vehicle combination to add an additional trailer which may be achieved by following the edges to nodes with multiple trailers 155A, 155B. The vehicle combination graph may be used to determine possible vehicle combinations when a trailer is removed from a vehicle combination, because a trailer has become unnecessary and it is more efficient to remove the trailer from the vehicle combination.

Returning to the discussion of FIG. 5, in one embodiment, a check may be made to determine if each permutation has been checked or other criteria have been fulfilled to indicate that a set of varied transportation plans has been processed (block 507). If the process has not completed, the process may continue to iterate through different configurations (block 505). If the iterations have completed then the process may select the least costly transportation plan that was analyzed (block 509). In one embodiment, the costs for each plan and the plans themselves are stored for later comparison. In another embodiment, the process may only track a current least cost plan and does not track other processed plans. The plan that is tracked at the end of the process may then be considered the least cost plan. In further embodiments, other selections schemes may be utilized including best improving, best non-deteriorating, first improving, first non-deteriorating, worst move or similar selection schemes.

In one embodiment, after a least cost configuration or transportation plan has been selected, the transportation plan may be optimized for vehicle activities using the routing move operation (block 511). The activities may be optimized on a vehicle combination by vehicle combination basis. In one embodiment, any search or heuristic may be used in combination with the routing method or within the routing method to optimize the routing. In another embodiment, the routing method may be applied to multiple vehicle combinations. For example, a transportation order may be transferred from one vehicle combination to another vehicle combination as it is transferred at stops on a route or the vehicle combination is altered. The transportation order may be transferred any number of times. After the vehicle activities are optimized the activities may be scheduled (block 513). The schedule method of the move operations may be used to affect the schedule optimization. In one embodiment, any search or heuristic may be used in combination with the scheduling method or within the scheduling method to optimize the scheduling. In another embodiment, the scheduling method may be applied to multiple vehicle combinations. For example, a transportation order may be assigned to multiple vehicle combinations as it is transferred at stops on a route or the vehicle combination is altered. In one embodiment, an optimizer utilizes an assignment generator or the move operators available through the assignment generator to affect these operations.

In one embodiment, the optimization process may be set to run for a set length of time, for a set number of iterations, until a desired solution quality level is achieved (e.g., a specific cost), convergence is detected, or limited by similar criteria. A check may be conducted to determine if the optimization limitation criteria have been met (block 515). If the criteria have been met then the process ends and the transportation plan is output (block 517). If the criteria have not been met then the transportation plan may be altered and reprocessed in an attempt to find a better solution (block 519). Transportation orders in the transportation plan may be reordered or similarly altered to change the starting conditions for the optimization process, which may result in different optimization results. The process may track previous transportation plans in case a subsequent plan is worse than the preceding. The best or optimal plan may then be output at the time that the optimization process constraints are met (block 515).

FIG. 6 is a diagram of one embodiment of a user interface for the vehicle scheduling system. The user interface may be used to monitor the scheduling process, view the results of the process, and adjust the settings of the process, rescheduling products or transportation orders and similar functions.

The user interface 601 may include a listing of vehicles 617. The listing may also include trailers or sub-sections of the vehicles. For example, with a train each box car may be listed. The user interface may also include a display of transportation orders organized by vehicles, trailers and compartments. The vehicles, trailers and compartments may be organized in a hierarchy. The hierarchy may be shown as a set of nested items. For example a truck 603 may be shown in the display. Information about the truck may be provided including the source location 611 and the destination location 613. Each trailer 609 and compartment associated with a truck may be listed. Each trailer and compartment may have an assigned name 605 and type 607 displayed. Other information may be displayed including the category, source 611, destination 613 and similar information.

In one embodiment, transportation orders 615 may be grouped under each assigned compartment. Transportation order information may also be displayed including the category, type 607, name 605, source 611, destination 613 and similar information about the order.

The data may be sorted, rearranged or similarly manipulated. The user interface may also provide menus for setting the configuration of the transportation determination module and processes. Transportation orders, compartments, trailers and vehicles may be rearranged and regrouped by dragging and dropping or similar interface mechanism.

In one embodiment, the scheduling system including the transportation determination module may be implemented as hardware devices. In another embodiment, these components may be implemented in software (e.g., microcode, assembly language or higher level languages). These software implementations may be stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
selecting a first transportation order;
selecting a vehicle combination to assign the first transportation order;
assigning the first transportation order to the vehicle combination;
selecting a first trailer in the vehicle combination; and
assigning the first transportation order to the first trailer.

2. The method of claim 1, further comprising:
checking a vehicle combination graph to determine if a second trailer or a vehicle can be added to the vehicle combination.

3. The method of claim 1, further comprising:
removing a trailer from a vehicle combination based on a vehicle combination graph.

4. The method of claim 1, further comprising:
executing a move operation to add the first transportation order to a transportation plan.

5. The method of claim 1, further comprising:
estimating a cost of a transportation plan based on trailer utilization.

6. The method of claim 1, wherein a vehicle combination indudes a vehicle and a trailer.

7. The method of claim 1, further comprising:
building a vehicle combination graph.

8. The method of claim 1, further comprising:
optimizing trailer assignments in a transportation plan.

9. The method of claim 1, further comprising:
sequencing loading and unloading activities for a trailer.

10. The method of claim 1, further comprising:
scheduling loading and unloading activities for a trailer.

11. The method of claim 1, further comprising:
determining if a route is feasible for the vehicle combination.

12. The method of claim 1, further comprising:
selecting a compartment of the first trailer; and
assigning the transportation order to the compartment.

13. The method of 4, further comprising:
optimizing the transportation plan using any one of a local search, a tabu search, simulated annealing, evolutionary algorithms, mixed integer linear programming or constraint programming.

14. A system comprising:
a demand order generating module, to generate a set of demand orders; and
a transportation determination module to receive the set of demand orders, generate a set of transportation orders and a transportation plan having transportation orders assigned to vehicle combinations and trailers.

15. The system of claim 14, further comprising:
a vehicle combination graph builder to generate a vehicle combination graph.

16. The system of 15, wherein the vehicle combination graph plots transitions between feasible vehicle combinations.

17. The system of 14, further comprising:
an optimizer to optimize the transportation plan including assignment of transportation orders to trailers.

18. The system of claim 14, further comprising:
a cost estimator to determine a cost for the transportation plan including trailer usage costs.

19. The system of claim 14, further comprising:
a constraint checker to determine if a transportation order assigned to a trailer meets applicable constraints.

20. The system of claim 14, further comprising:
a user interface module to display a set of transportation orders organized by vehicle and trailer.

21. A machine readable medium having a set of instructions stored therein which when executed cause a machine to perform a set of operations comprising:
receiving a set of transportation orders;
iterating through permutations of the set of transportation orders distributed across trailers of a set of vehicle combinations; and
identifying a configuration that meets a set of predetermined constraints related to the trailers and the set of transportation orders.

22. The machine readable medium of claim 21, having a further set of instructions stored therein which when executed cause a machine to perform a set of operations further comprising:
identifying a least cost configuration for the set of transportation orders distributed across trailers of the set of vehicle combinations.

23. The machine readable medium of claim 21, having a further set of instructions stored therein which when executed cause a machine to perform a set of operations further comprising:
displaying the set of transportation orders organized by vehicle and trailer.

24. The machine readable medium of claim 21, having a further set of instructions stored therein which when executed cause a machine to perform a set of operations further comprising:
optimizing the configuration for vehicle combination routing and scheduling.

25. An apparatus comprising:
means for receiving a set of transportation orders;
means for iterating through permutations of the transportation orders distributed across trailers of a set of vehicles; and
means for identifying configurations that meet a set of predetermined criteria related to the trailers and the set of transportation orders.

26. The apparatus of claim 25, further comprising:
means for generating a configuration of the set of transportation orders distributed across trailers.

27. The apparatus of claim 25, further comprising:
means for displaying the set of transportation orders organized by vehicle and trailer.

28. The apparatus of claim 25, further comprising:
means optimizing a placement of the set of transportation orders across trailers of a vehicle combination during each iteration.
